(19) United States
(12) Patent Application Publication
(10) Pub. No.: US 2011/0138018 A1
(43) Pub. Date: Jun. 9, 2011

(54) MOBILE MEDIA SERVER

(75) Inventors: Vijayalakshmi R. Raveendran, San Diego, CA (US); Soham V. Sheth, San Diego, CA (US); Xun Luo, San Diego, CA (US); PhaniKumar K. Bhamidipati, San Diego, CA (US)

(73) Assignee: QUALCOMM Incorporated, San Diego, CA (US)

(21) Appl. No.: 12/960,220

(22) Filed: Dec. 3, 2010

Related U.S. Application Data
(60) Provisional application No. 61/266,851, filed on Dec. 4, 2009.

(51) Int. Cl. G06F 15/16

(52) U.S. Cl. 709/219

(57) ABSTRACT

Mobile media server (MMS) includes MMS hosts and an MMS clients utilized for ubiquitous sharing of media content. An MMS host, which may be deployed on a mobile terminal such as a cellular telephone, can establish a logical link with an MMS client over an IP interface and initiate a streaming session with the MMS client. The MMS host may further retrieve media content from any source, such as a network source, locally stored content, or a camera and/or microphone on the MMS host, and serve the media content to the MMS client over the logical link.

### CROSS-REFERENCE TO RELATED APPLICATION(S)

This application claims the benefit of U.S. Provisional Application No. 61/266,851, entitled “Mobile Media Server,” filed Dec. 4, 2009, which is expressly incorporated by reference herein in its entirety.

### BACKGROUND

1. Field

The disclosure relates to multimedia content and, more particularly, techniques for transferring multimedia content between devices.

2. Background

A multimedia ecosystem may include a number of multimedia devices that communicate multimedia content between one another using a particular set of multimedia file formats. With the recent rise of wireless networks, many multimedia file formats have evolved to facilitate communication over these wireless networks. Multimedia devices that each implement the same set of multimedia file formats for communicating multimedia content between one another over a wireless network may form what may be referred to as a wireless multimedia ecosystem. These multimedia devices within such wireless multimedia ecosystems may include particular types of wireless modems to communicate via the one or more wireless networks.

A number of different types of modems exist by which to transfer multimedia content wirelessly. Example wireless modems include Wireless Personal Area Network (WPAN) modems (e.g., Bluetooth™ modems), cellular modems (e.g., Universal Mobile Telecommunications System or UMTS modems, Global Systems for Mobile communications or GSM modems, Long Term Evolution or LTE modems, and cdma2000 modems), Wireless Wide Area Network (WWAN) modems (e.g., Worldwide Inter-operability for Microwave Access or WiMAX modems), and Wireless Local Area Network (WLAN) modems (e.g., Wi-Fi™ modems or other modems compliant with one or more of the Institute of Electrical and Electronics Engineers or IEEE 802.11 set of standards). Each of these different modems may implement different forms and levels of Forward Error Correction (FEC), communicate via different wireless communication channels, and consume different levels of power.

In addition, a number of different multimedia file formats exist for segmenting and encapsulating the multimedia content. The multimedia file formats may use specific transport and/or application layer protocols to encode the multimedia content or particular container or wrapper file formats. Often, these different file formats may be specific to a particular application, such as streaming multimedia content. For example, a desktop computer may store digital video multimedia content formatted in accordance with a container format, commonly referred to as “MP4,” defined by a Moving Pictures Expert Group (MPEG) 4, part 14 for these streaming applications. Other file formats for streaming multimedia content over a public network, such as the Internet, include an application layer protocol referred to as a Realtime Transport Protocol (RTP).

Given the wide variety of both types of wireless modems and file formats, multimedia ecosystems are often formed for very specific multimedia applications or, in some instances, groups of related multimedia applications. As a result, multimedia devices of one multimedia ecosystem typically only communicate with multimedia devices located in the same multimedia ecosystem. Moreover, while a multimedia device may belong to one or more multimedia ecosystems, inter-ecosystem communication is typically limited or prohibited by multimedia content providers to prevent wide-spread digital dissemination of the multimedia content for free. Consequently, multimedia content may tend to become fixed within a particular multimedia ecosystem.

### SUMMARY

The normal server-client paradigm for the sharing of media content involves a client, such as an Internet video consumer, selecting desired media content and initiating a streaming session to retrieve that content. In aspects of the present disclosure, the paradigm is reversed: that is, a server of media content initiates a data sharing session with a client. Moreover, the server may share locally-stored media content, or may act as a bridge, retrieving media content from any suitable source such as the Internet or even a television broadcast, and share that content with one or more clients over a logical link such as an IP interface.

In an exemplary aspect of the disclosure, a method is used to serve media from a media server. The method includes establishing a logical link with a client utilizing an Internet Protocol interface, initiating, over that logical link, a streaming session with the client, retrieving media content from a media source, and serving the media content to the client over the logical link.

In another exemplary aspect of the disclosure, a method is used to receive, at a client, media from a media server. Here, the method includes discovering the media server, subscribing to the media server, and receiving media content over a logical link established by the media server.

In yet another exemplary aspect of the disclosure, an apparatus may serve media. Here, the apparatus includes means for establishing a logical link with a client utilizing an Internet Protocol interface, means for initiating, over the logical link, a streaming session with the client, means for retrieving media content from a media source, and means for serving the media content to the client over the logical link.

In still another exemplary aspect of the disclosure, a computer program product includes a computer-readable medium having code for establishing a logical link with a client utilizing an Internet Protocol interface; code for initiating, over the logical link, a streaming session with the client; code for retrieving media content from a media source; and code for serving the media content to the client over the logical link.

In still another exemplary aspect of the disclosure, an apparatus for serving media includes at least one processor and a memory coupled to the at least one processor. Here, the at least one processor is configured to establish a logical link with a client utilizing an Internet Protocol interface; to initiate, over the logical link, a streaming session with the client; to retrieve media content from a media source; and to serve the media content to the client over the logical link.

These and other aspects of the disclosure will become readily apparent upon a review of the detailed description, which follows.

### BRIEF DESCRIPTION OF THE DRAWINGS

FIG. 1 is a conceptual diagram illustrating an exemplary system utilizing MMS in accordance with an aspect of the present disclosure.

FIG. 2 is a block diagram illustrating exemplary apparatuses including an MMS host and an MMS client.

FIG. 3 is a block diagram illustrating further aspects of the MMS host and the MMS client.

FIG. 4 is a conceptual block diagram illustrating branching of media contents while playing back the media contents in a server-only mode.

FIG. 5 is a conceptual block diagram illustrating branching of media contents to be served in a concurrent host and client playback mode.

FIG. 6 is a diagram with flow charts to illustrate a process for serving media content in accordance with an aspect of the disclosure.

FIG. 7 is a flow chart illustrating a process for receiving media content at an MMS client in accordance with an aspect of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

According to various aspects of the instant disclosure, a system, architecture and methods are used to construct a mobile media server (MMS). In some aspects, MMS may have both hardware-agnostic and hardware-dependent components. In one example, MMS may be deployed on mobile devices. A mobile device that has MMS deployed and serves media content to other devices is called an MMS host. A device that consumes media content from an MMS host is called an MMS client. The digital media served by MMS hosts are referred to as media contents. Media contents may include, but are not limited to audio, video, pictures, text, graphics, sensor data, live camera capture, synthesized digital content, production software files, metadata, etc. Broadly, the media contents may include any data structure being a non-random aggregation of data irrespective of its mode of storage or presentation.

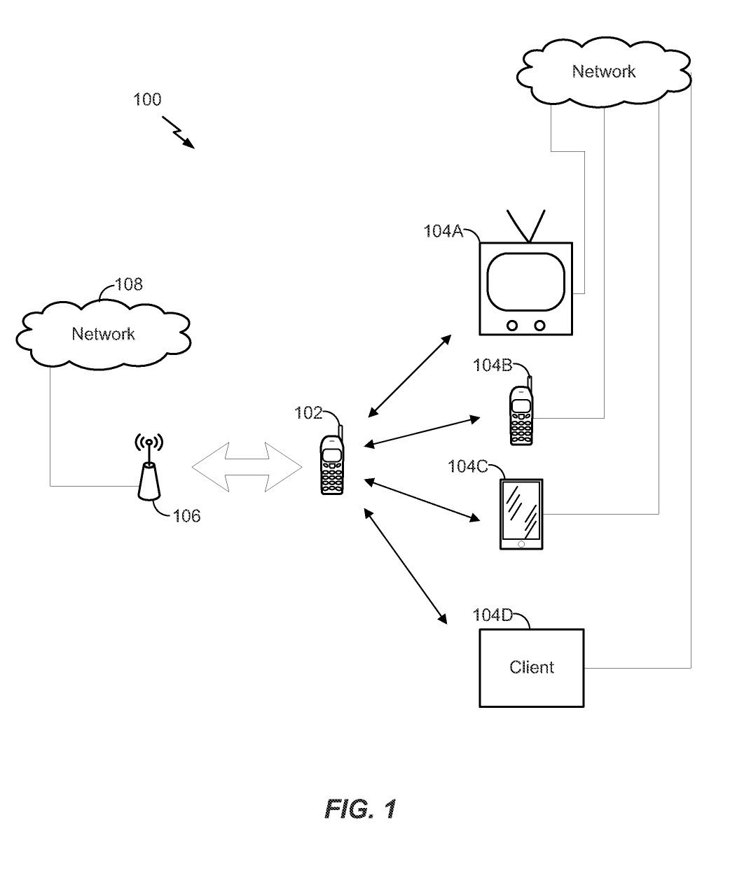

FIG. 1 is a conceptual diagram illustrating an exemplary system 100 utilizing MMS in accordance with an aspect of the present disclosure. In the system 100, an MMS host 102 is communicatively coupled with a base station 106. The coupling between the MMS host 102 and the base station 106 may be over any suitable wireless air interface, such as a UMTS air interface, an LTE air interface, a cdma2000 air interface, etc. The base station 106 may be coupled through a suitable backhaul interface to a packet-based network 108, such as the Internet. At the other end, the MMS host 102 may be communicatively coupled with one or more MMS clients 104A, 104B, 104C, and/or 104D. Here, the MMS host 102 shares a logical link with the MMS client 104, for example, any suitable link following the Internet protocol (IP).

The coupling between the MMS host 102 and the respective MMS client 104 may be a direct coupling, e.g., through a wired interface or a wireless personal area network (PAN) interface such as a Bluetooth™ interface, or any other suitable direct interface. In this way, an ad-hoc media content streaming session can be initiated for the impromptu sharing of media content without the need for connection to an external network.

Alternatively or additionally, the coupling between the MMS host 102 and the respective MMS client 104 may be through the packet-based network 108. That is, the respective MMS client 104 may be coupled to the network 108 through any suitable means, such as an Ethernet connection, a fiber optic connection, or through an air interface coupled to the base station 106 or another base station utilizing any suitable communication protocol.

In an aspect of the disclosure, the MMS host 102 may initiate a streaming session with one or more of the MMS clients 104A, 104B, 104C, and/or 104D. In the streaming session, packets of data may be delivered to one or more of the MMS clients 104 over a logical link in a stream, which may be received by the MMS client 104 and rendered in real-time, or stored for later rendering if desired.

In a real-time stream, the MMS client 104 receives and renders the media content without caching or collecting the media content for an extended period of time. Here, if a packet arrives late, and the presentation time to playback is passed, that packet may be discarded. Thus, the MMS host 102 and the MMS client 104 may coordinate the stream to insure that the media content may be played back nearly in real time. In an alternate approach, the MMS client 104 may accumulate the media content in local memory until it receives a certain amount of content, at which point the received media content will be played back without packets being dropped for being late.

According to some aspects of the disclosure, the streaming session may be initiated by either the MMS host or the MMS client. That is, the MMS host 102 may initiate a session to push media content to an MMS client 104. Further, the MMS client 104 may initiate a session to pull media content from the MMS host 102.

The connection topology between the MMS host 102 and MMS client 104 is a logical link. According to an aspect of the disclosure, the logical link is generally network agnostic. That is, the link established between the MMS host 102 and the MMS client 104 may be based on a logical link such that the lower layer details of the particular network being utilized may vary. For example, a logical link with an MMS client 104 may be established utilizing an internet protocol (IP) interface provided in the MMS host 102. In this way the MMS client 104 can be connected to the MMS host 102 through a wide area network (WAN), wireless wide area network (WWAN), local area network (LAN), wireless local area network (WLAN) or any suitable network link as long as the link is IP-based.

The link between the MMS host 102 and the respective MMS client 104 is generally a two-way link, including a forward link and a backward link. The forward link is the link maintained by the MMS host, in the direction from the MMS host to the MMS client. In some examples, multiple forward links may be utilized. That is, a plurality of forward links from one MMS host 102 to a plurality of MMS clients 104 may be maintained. In another example, a broadcasting forward link can be used wherein a single forward link from one MMS host 102 is broadcasted to a plurality of MMS clients 104. In this example, the same information can be transmitted utilizing less band width to multiple MMS clients 104 than required to utilize multiple forward links. The backward link is a link generally maintained by the MMS clients, in the direction from the MMS client 104 to the MMS host 102. In one example, multiple backward links may be maintained. That is, a plurality of backward links may be maintained from one MMS client 104 to a plurality of MMS hosts 102. Information on the backward link may include requests from the MMS client 104; control information (such as information that may be indirect under the context of bridge content sources, to be discussed later); feedback about the forward link; or interaction if the content being served on the forward link is interactive content. In a further example, multiple two-way links may be utilized. Multiple two-way links can enable each MMS client 104 to consume different media contents, i.e., different two-way links may feature different streaming parameters and quality information according to the particular characteristics of the link between the respective MMS host 102 and MMS client 104.

The type of relationship between a respective MMS host 102 and MMS client 104 may be a one-to-one relationship in which an interface is established between one MMS host 102 and one MMS client 104. Another type of relationship may be one-to-many. Here, one MMS host 102 can serve the same or various media contents to many MMS clients 104. Another type of relationship may be a many-to-one connection. Here, one MMS client 104 can consume media content from many MMS hosts 104. For example, an MMS client 104 may switch playback among plural subscriptions to plural MMS hosts 102 or one or more MMS clients 104 may concurrently play back one or more subscribed media contents. Another type of relationship is a many-to-many relationship in which MMS clients 104 each consume different media contents from different MMS hosts 102.

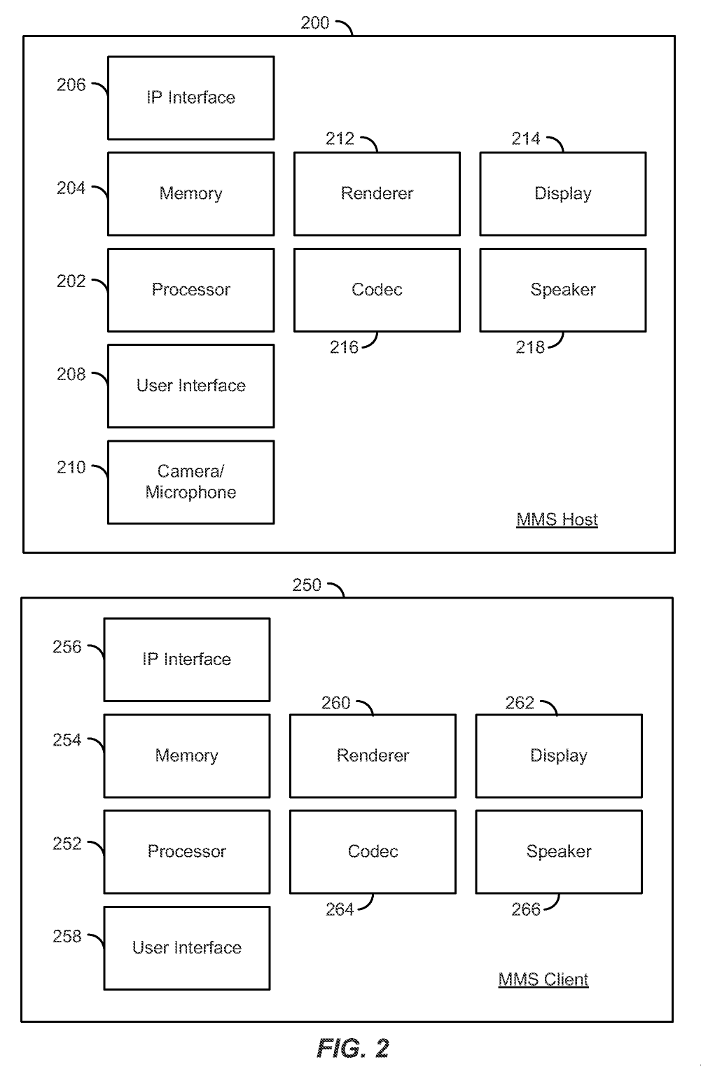

FIG. 2 is a block diagram illustrating exemplary apparatuses including an MMS host 200 and an MMS client 250. The MMS host 200 may represent one example of the MMS host 102 illustrated in FIG. 1, and the MMS client 250 may represent one example of the MMS client 104 illustrated in FIG. 1.

Here, the MMS host 200 includes a processor 202 and an accompanying memory 204. The MMS host 200 further includes an IP interface 206 for communicating over an IP network. A user interface 208 may provide an input-output function for a user to communicate utilizing the MMS host 200 such as, for example, a keyboard and a screen. A camera and/or microphone 210 may provide a source of media content or other data for the MMS host 200 to be sent to the processor 202. A renderer 212 is a block for rendering data from any suitable source, e.g., processing media content in such a way that it can be sent to a display 214 and/or a speaker 218 to be presented to a user of the MMS host 200, and/or directed to the IP interface 206. Codec 216 is a block used for coding and decoding of media content to be provided to or from the renderer 212.

The illustrated MMS client 250 includes a processor 252 and a memory 254. An IP interface 256 can provide an interface to an IP network. A user interface 258 provides input and output functions to a user of the MMS client 250, such as a keyboard or a screen. A renderer 260 is similar to the renderer 212 in the MMS host 200 in that it may be considered as a block for rendering any form of media content suitably for display and/or playing audibly. The display 262 can provide display functions for a user and a speaker 266 can provide audio output for a user. A codec 264 can provide coding and decoding function for media content to be sent to or from the renderer 260.

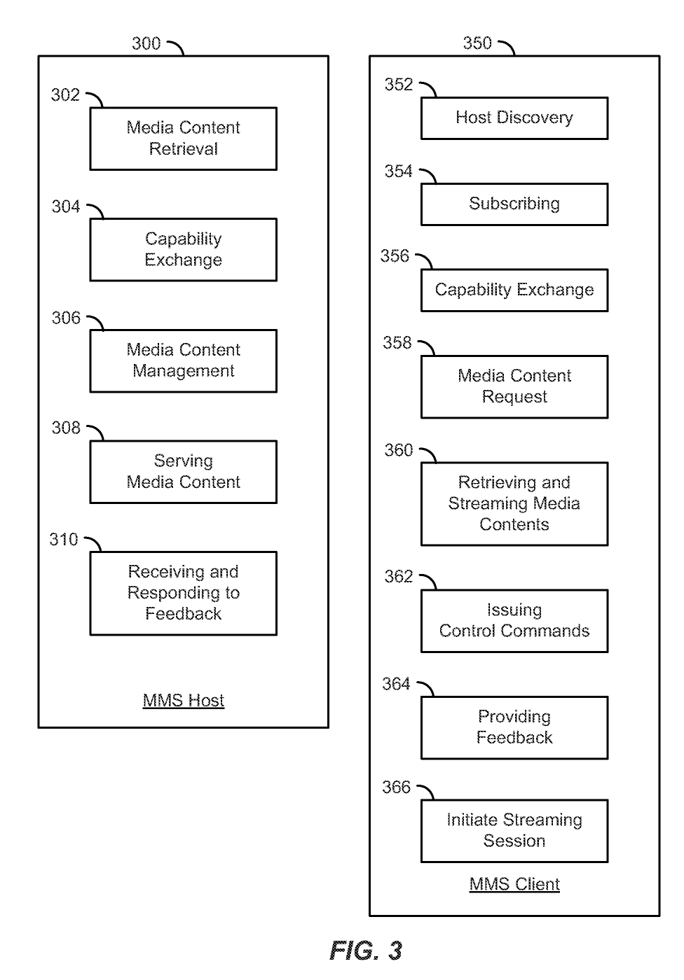

FIG. 3 is another block diagram illustrating further aspects of the MMS host 300 and the MMS client 350. Here, the MMS host 300 may be the same as the MMS host 200 illustrated in FIG. 2, or it may have some differences within the scope of the current disclosure. Similarly, the MMS client 350 may be the same as the MMS client 250 illustrated in FIG. 2, or it may have some differences from the MMS client 250 within the scope of the disclosure.

Here, the MMS host 300 is illustrated with blocks showing modules for performing certain functions, including a module 302 for media content retrieval; a module 304 for exchanging capabilities with the MMS client 350; a module 306 for managing media content within the MMS host 300; a module 308 for serving media contents to the MMS client 350; and a module 310 for receiving and responding to feedback from the MMS client 350.

The module 302 for retrieving media contents may retrieve various types of media content from different sources, and in some aspects the module 302 may initiate retrieval of those media contents from those sources. The sources of those media contents may be one or more of many suitable content sources, such as, but not limited to: locally stored media contents; network provided media contents; and/or live user-generated media contents.

For the locally stored media contents, the MMS host 300 may act as a network-attached storage (NAS) server. Here, referring once again to FIG. 2, the MMS host 200 may store the media contents in the memory 204.

For the network provided media content, the MMS host 300 may serve as a media bridge that links a network-based media content source (e.g., contents from any suitable network) with one or more MMS clients. These bridged media contents may come from sources such as: an over-the-air broadcast, such as broadcast television or radio signals; a forward link only (e.g., MediaFLO™), cellular media broadcast; live streaming media contents from a remote device such as another mobile device, computer or a server; Internet-based media content such as video provided by YouTube™; or video telephony. Here the MMS host 300 may be participating in a video telephony session, e.g., over a cellular broadband network. That is, the MMS host 300 may serve the live video with one or more MMS clients. Serving multiple MMS clients at the same time can create a multi-viewer video conferencing experience.

When the source of the media contents is a network, referring again to FIG. 2, the media contents may be provided to the MMS host 300 by way of the IP interface 206. In a further aspect of the disclosure, the media contents may include live user-generated media contents, such as video taken by a camera on the MMS host 300 and/or snapshots from a display. When the media contents are sourced by a camera, such as the camera 210 illustrated in FIG. 2, an image or video stream produced by the camera viewfinder and a corresponding imager equipped on the MMS host 200 may provide a video stream to a codec 216 to be sent by way of, for example, the IP interface 206 towards the MMS client 200. When media content includes snapshots or screenshots, these contents may include real time and/or continuous computer desktop snapshots from the MMS host 300 which may be streamed to the MMS client.

Media content retrieval may be initiated by either the MMS host 300 or the

MMS client 350. The MMS host 300 may initiate media content retrieval by utilizing the user interface, such as user interface 208 illustrated in FIG. 2 on the MMS host 200. When the retrieval of the media content is initiated by the MMS client 350, the MMS host 300 may receive a request from the MMS client 350 for certain media content stored on the MMS host 300, for example, using the media content resource name or file name. This request may also direct the MMS host 300 to retrieve media content from one of the network-provided sources discussed above.

The module 304 for extending capabilities with an MMS client may obtain the MMS client's capabilities through a capability exchange and negotiation with the respective MMS client. In one aspect of the disclosure, the module 304 for exchanging capabilities may include the processor 202, the memory 204, and the IP interface 206 within the MMS host 200 illustrated in FIG. 2. This exchange of capabilities may be automatic, occurring at the moment when a connection with an MMS client is established. In another aspect of the disclosure, the exchange capabilities may be prompted or updated, for example, when a certain feature is enabled on an MMS client. In one example, if a user turns on a 3D rendering capability on a television having MMS client deployed, the television may inform an MMS host that the 3D capability is now available.

The module 306 for managing media contents may provide functions such as adding or managing metadata of media contents; indexing available media contents into resource listing; providing content channel lists; and altering media contents. In one aspect of the disclosure the module 306 for managing media contents may include, referring again to FIG. 2, the processor 202 and the memory 204. The module 306 for managing media contents may further manage metadata of media contents. Such metadata can include keywords or tags appended or included within media contents, and closed captions for video media contents. The management of media contents may also index available media contents into resource listings, such as playlists or channel lists. This index may be compiled by retrieving metadata or any other information related to media contents from the source of those media contents. The indexing may then include compiling the corresponding information into an index and providing that index to the MMS client so that the client may be aware of certain details of the media contents that are available for streaming through or from the MMS host. The module 306 for managing media contents may also provide a content channels list, that is, a list of channels for MMS clients to subscribe.

The module 306 for managing media contents may also alter media contents, although in some aspects of the disclosure, the MMS host 300 may serve contents to MMS clients in their original form as provided from the source of those media contents. Altering of the media contents may include adding media format wrappers. That is, the MMS host 300 may wrap one form of media content into another format. For example, a series of snapshots can be concatenated and wrapped into a video format to provide a video clip.

The altering of the media contents may also include upscaling, downscaling or otherwise altering the quality of the media contents. Here, upscaling of video media contents may provide a higher resolution of video when an MMS client is known to house a high video resolution. Downscaling of media contents may be desired when network bandwidth is limited.

Altering of the media contents may also include altering spatial properties of the media contents, such as the resolution and/or aspect ratio of video media contents. Additionally, the altering of the media contents may include altering information entropy properties, such as a QP factor of a video. Additionally, live 2D-to-3D content conversion may be accomplished through depth or delta extraction techniques.

The altering of the media contents may further include de-multiplexing audio content from video content. For example, the audio content may be streamed to one or more MMS clients while the video content may be played back on the MMS host. The audio content may further be transcoded or enhanced with spatial effects. In one aspect, the audio contents may also be re-multiplexed with other video contents to be served to MMS clients. The altering of the media contents may further include multiplexing or re-multiplexing a plurality of associated media contents, such as the contents from multiple sources into a single stream. For example, audio media contents may be sourced from a first source and video contents may be sourced from a second source. These contents may be multiplexed and provided to a single MMS client.

Further, the altering of the media contents may include transcoding of the media contents. That is, the MMS host 300 may change the coding format of the media contents. Such transcoding may be desired because the coder capabilities of different MMS clients may vary, and suitable encoding of the media contents can be accomplished and provided to the corresponding MMS clients. With suitable processing capabilities, media content transcoding at an MMS host 300 can be performed with a negligible or nominal latency. Advanced, highly compressed forms of encoding may be used to reduce the required bandwidth when the MMS client is known to have a suitably advanced decoder. On the other hand, less compressed forms of encoding may be used when the MMS client is known to lack advanced decoding capabilities. In one example, MPEG4 encoded video may be transcoded to MPEG2 encoding, or AAC encoded audio may be transcoded into PCM encoding for an MMS client that lacks an advanced decoder. In another example, MPEG2 encoded video may be transcoded into MPEG4 encoding, or PCM encoded audio may be transcoded into AAC encoding to save network bandwidth when an MMS client is known to include suitable decoders that can properly decode these more advanced forms of media contents. In yet another example, if sufficient bandwidth is known to be available for a streaming session, the MMS host 300 may decode media contents into a raw format requiring only a minimum level of decoding capabilities for the respective MMS client. According to various aspects of disclosure, the transcoding of the media contents in the MMS host may be performed by the Codec 216 within the MMS host 200 illustrated in FIG. 2.

The module 308 serving the media contents to the MMS client may be accomplished, referring again to FIG. 2, by the processor 202, the memory 204 and the IP interface 206. To serve media contents, those media contents may pass through a playback pipeline. That is, a stream of media contents may pass from its source through the playback pipeline to be rendered for viewing and/or listening by a user. Here, the term rendering is used broadly, and includes graphically rendering a video or image file to be displayed, processing an audio file to be reproduced as a audio signal or otherwise suitably processing any corresponding media content to be presented in a particular desired format for the user.

According to various aspects of the disclosure, the serving of media contents can be accomplished utilizing one of two playback modes: server-only and concurrent host and client playback. In a server-only playback mode, media contents may be retrieved from their source and served to the MMS client to be played back there. In a concurrent host and client playback mode, a media playback pipeline may be branched such that media contents can concurrently be played back at the MMS host 300 and/or one or more MMS clients.

That is, the serving of the media contents may include branching, which is when a media content stream is duplicated to one or more copies as it flows through the media playback pipeline. Branching of the media content stream enables local playback and/or remote playback. In local playback, one or more of the duplicated copies of the stream may be rendered locally on the MMS host 300, for example, referring to FIG. 2, at the display 214 and/or the speaker 218. In remote playback, one or more of the duplicated copies of the stream may be integrated with any other media pipelines at any suitable stage at one or more MMS clients. These branched streams may be provided to the MMS clients in their original form or in an altered form as discussed above.

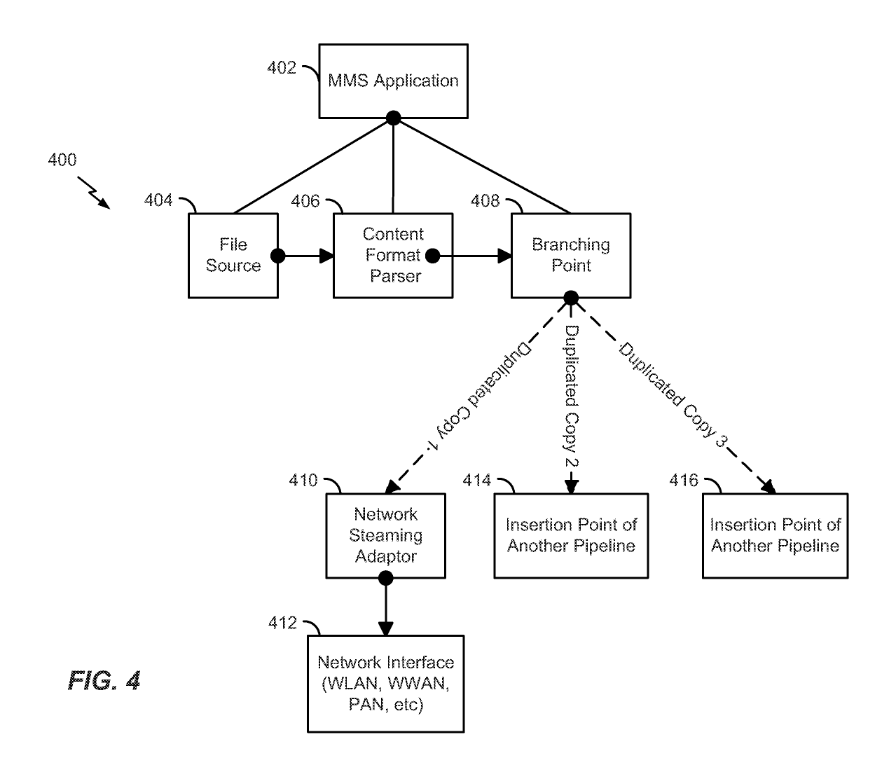

FIG. 4 is a conceptual block diagram illustrating branching of media contents while playing back the media contents in a server-only mode. In the illustration, an MMS application 402 manages the retrieval of media contents from the file source 404, which media contents then flow through a media playback pipeline to a content format parser 406. At this point the pipeline reaches a branching point 408. At the branching point 408, in this example, the media content stream is branched or duplicated to three duplicated copies, labeled duplicated copy 1, 2 and 3 in the illustration. Duplicated copy 1 passes through a network streaming adapter 410. Here, for example, referring back to FIG. 2, the network streaming adapter may be the IP interface 204. The IP interface may pass through a network interface 412, such as a WLAN, WWAN, PAN or any other suitable network interface to be eventually received by an MMS client. Duplicated copies 2 and 3 each pass through a suitable insertion point of another pipeline 414 and 416. These playback pipelines may be within the MMS host or within the MMS client.

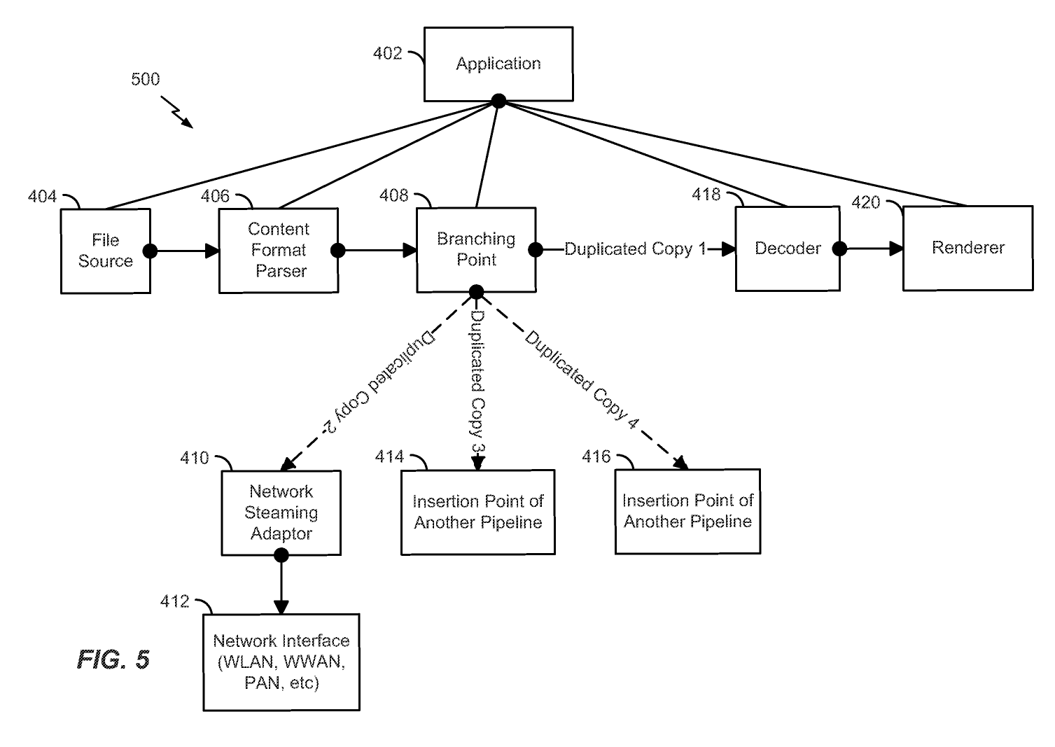

FIG. 5 is a conceptual block diagram illustrating branching of media contents to be served in a concurrent host and client playback mode. In much the same way as illustrated in FIG. 4, a media playback pipeline includes a file source 404, a content format parser 406 and a branching point 408. Here, however, the branching point 408 provides four duplicated copies of the media content stream. In this illustration, duplicated copy 1 passes through a local decoder 418 and to a local renderer 420. In one example, the decoder 418 may correspond to the codec 216 illustrated in FIG. 2, and the renderer 420 may correspond to the renderer 212 illustrated in the MMS host 200 of FIG. 2. In this way, media content may be rendered locally on the MMS host simultaneously with a remote playback and rendering of the media content at a remote MMS client.

In a further aspect of the disclosure, the branching of the media content stream may include dynamic branching. That is, aspects of the branching may be controlled at run time, for example, by the MMS host 300 in response to various conditions. Conditions which may affect the branching of the media content stream may include factors such as: the encoding of the media content; a data rate of the transmission; or the existence of a link to an MMS client modified by the initiation and termination of corresponding links with the MMS client.

Referring once again to FIG. 3, the module 310 for receiving and responding to feedback may be receive feedback information from an MMS client such as information about network conditions corresponding to the streaming session; error concealment measures taken by an MMS client; or playback control commands from an MMS client. For example, as described above with relation to FIG. 2, an MMS client may include a user interface from which a user of the MMS client can input playback control commands to be provided to the MMS host. The MMS host may then correspondingly respond to the feedback information provided by the MMS client. In some aspects of the disclosure, the module 310 for receiving and responding to the feedback information may include the IP interface 206, the memory 204 and the processor 202 within the MMS host 200 illustrated in FIG. 2.

Referring still to FIG. 3, the MMS client 350 is illustrated by a block diagram showing various modules for performing different functions by the MMS client 350. In one aspect of the disclosure, the illustrated MMS client 350 may be the same MMS client as illustrated in FIG. 2 as MMS client 250. Here the MMS client 350 may include a module 352 for discovering MMS hosts; a module 354 for subscribing to one or more MMS hosts; a module 356 for exchanging capabilities with one or more MMS hosts; a module 358 for requesting media contents from an MMS host; a module 360 for retrieving and streaming media contents from the MMS host; a module 362 for issuing control commands to an MMS host; and a module 364 for providing feedback to an MMS host. Each of the modules 352, 354, 356, 358, 360, 362 and 364 may include the processor 252, memory 254 and IP interface 256 of the MMS client 250 illustrated in FIG. 2.

Discovery of MMS hosts by the module 352 for discovering hosts may include utilizing the IP interface 256, illustrated in FIG. 2, to retrieve information about the availability of MMS hosts. The module 354 for subscribing to one or more MMS hosts may similarly include utilizing the IP interface 256 to receive and/or request subscriptions to the MMS hosts. The module 356 for exchanging capabilities with the MMS host may provide information about the MMS client's capabilities to be utilized by the MMS host to provide suitable media contents to the MMS client 350. This exchange of capabilities may be automatic upon the establishment of a connection with an MMS host, or the exchange may be prompted or updated, for example, when a certain feature is enabled on an MMS client 350.

The module 358 for requesting media contents from the MMS host may request stored content in its original form or any suitable derived form of the original contents. The module 360 for retrieving and streaming media contents may utilize one or more logical links with one or more MMS hosts to retrieve and stream the media contents. The module 362 for issuing control commands to an MMS host may issue control commands such as initializing a playback, play, pause, stop, fast forward, rewind, tear down or any other suitable command to the MMS host corresponding to the playback process. This module 362 for issuing control commands may take input from a user interface 258 within the MMS client 250 as illustrated in FIG. 2. The module 364 for providing feedback information to one or more MMS hosts about the media content streaming status may provide feedback on the link quality, on the decoding quality accomplished by the MMS client and/or on a feedback corresponding to the user experience at the MMS client. The module 366 for initiating a streaming session with an MMS host may enable the MMS client to receive media content over a streaming session initiated by the MMS client as well as a streaming session initiated by the MMS host.

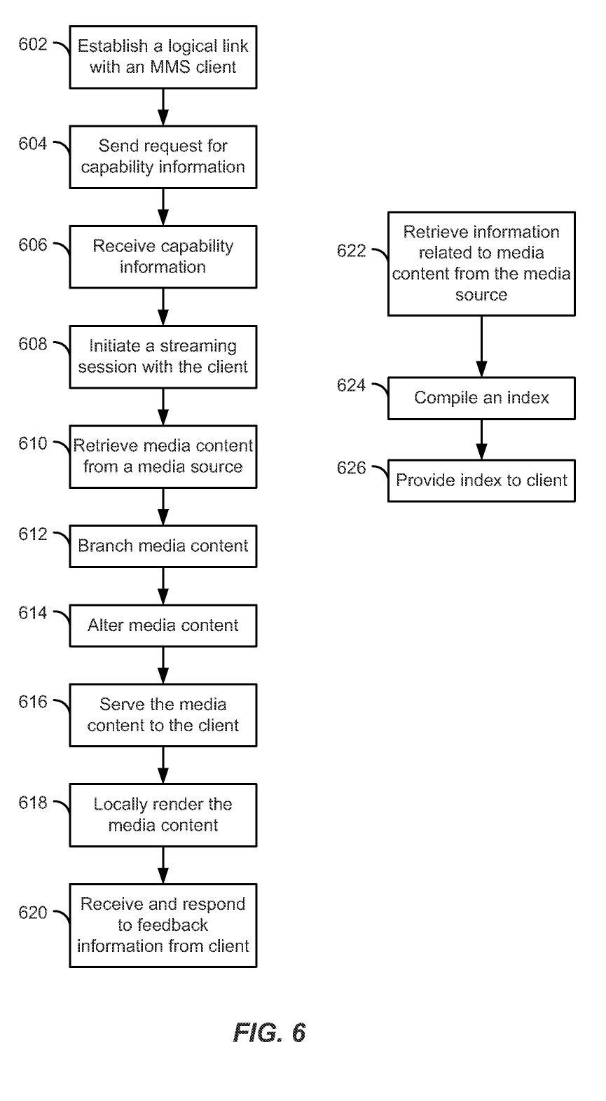

FIG. 6 is a diagram with flow charts to illustrate a process for serving media content in accordance with an aspect of the disclosure. In accordance with the exemplary process, in block 602, an MMS host establishes a logical link, e.g., a link that utilizes the Internet protocol, with an MMS client. In block 604, the MMS host may send a request for capability information corresponding to capabilities of the MMS client; and in block 606 the MMS host may receive the capability information from the MMS client in response to the request. In block 608, the MMS host may initiate, over the logical link, a streaming session with the MMS client.

In block 610, the MMS host may retrieve media content from a suitable source, such as local memory, a local camera, or a network-based source. In block 612, the MMS host may branch the media content, e.g., by duplicating the media content into a plurality of media content branches. In block 614, the MMS host may alter the media content corresponding to one or more of the plurality of media content branches. In block 616, the MMS host may serve the media content to the client over the logical link.

In block 618, corresponding to a simultaneous host-client playback mode, the MMS host may locally render the media content. In block 620, the MMS host may receive and respond to feedback information from the MMS client.

Blocks 622-626 represent a process for indexing media content for an MMS client. In block 622, the MMS host may retrieve information related to the media content from the media source. In block 624, the MMS host may compile an index corresponding to the information, and in block 626, the MMS host may provide that index to the MMS client.

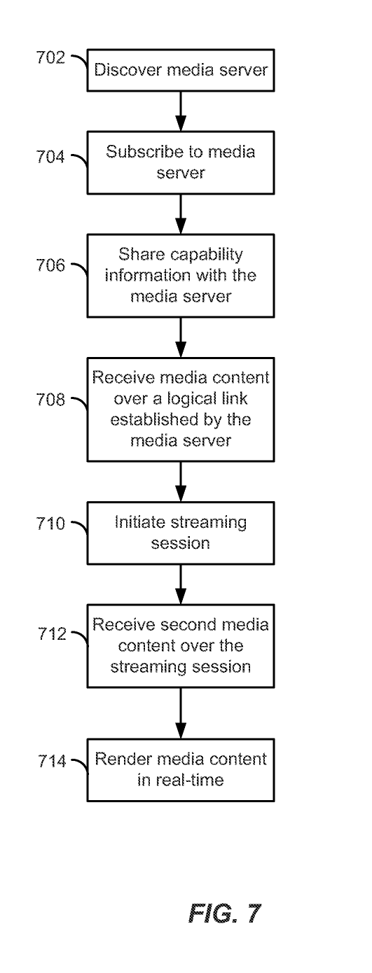

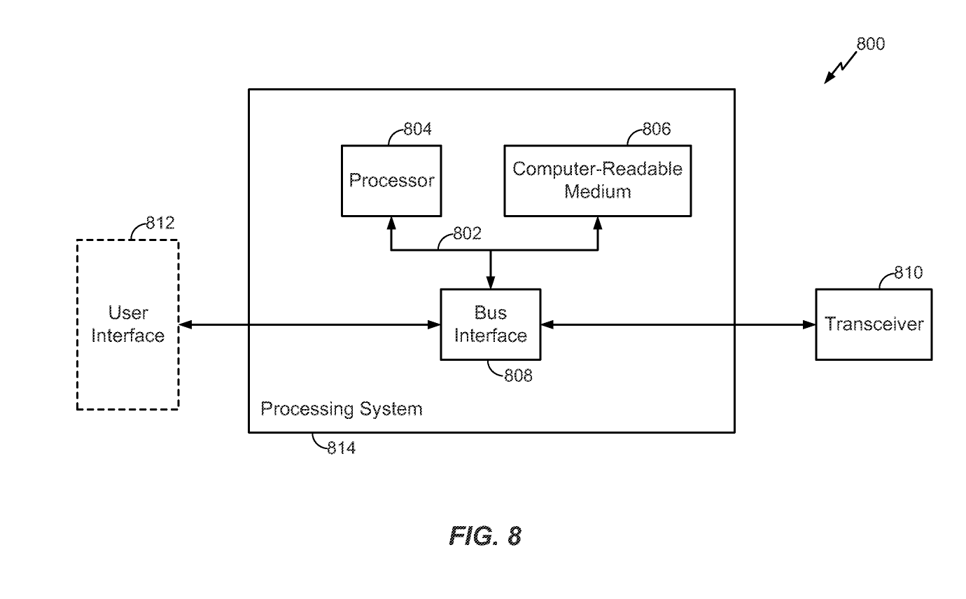

FIG. 7 is a flow chart illustrating a process for receiving media content at an MMS client in accordance with an aspect of the disclosure. In block 702, the MMS client discovers an MMS host; and in block 704 the MMS client subscribes to the discovered MMS host. In block 706, the MMS client may share capability information with the MMS host corresponding to a capability to utilize the media content. In block 708 the MMS client receives the media content over a logical link established by the media server. In block 710, the MMS client may initiate a “pull” streaming session, and in block 712, the MMS client may receive second media content over the streaming session just initiated.

Several aspects of MMS systems have been presented with reference to various apparatus and methods. These apparatus and methods will be described in the following detailed description and illustrated in the accompanying drawing by various blocks, modules, components, circuits, steps, processes, algorithms, etc. (collectively referred to as “modules”). These modules may be implemented using electronic hardware, computer software, or any combination thereof. Whether such modules are implemented as hardware or software depends upon the particular application and design constraints imposed on the overall system.

By way of example, a module, or any portion of a module, or any combination of modules may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium may include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

FIG. 8 is a conceptual diagram illustrating an example of a hardware implementation for an apparatus 800 employing a processing system 814. In this example, the processing system 814 may be implemented with a bus architecture, represented generally by the bus 802. The bus 802 may include any number of interconnecting buses and bridges depending on the specific application of the processing system 814 and the overall design constraints. The bus 802 links together various circuits including one or more processors, represented generally by the processor 804, and computer-readable media, represented generally by the computer-readable medium 806. The bus 802 may also link various other circuits such as timing sources, peripherals, voltage regulators, and power management circuits, which are well known in the art, and therefore, will not be described any further. A bus interface 808 provides an interface between the bus 802 and a transceiver 810. The transceiver 810 provides a means for communicating with various other apparatus over a transmission medium. Depending upon the nature of the apparatus, a user interface 812 (e.g., keypad, display, speaker, microphone, joystick) may also be provided.

The processor 804 is responsible for managing the bus 802 and general processing, including the execution of software stored on the computer-readable medium 806. The software, when executed by the processor 804, causes the processing system 814 to perform the various functions described infra for any particular apparatus. The computer-readable medium 806 may also be used for storing data that is manipulated by the processor 804 when executing software.

The processing system 814 described in relation to FIG. 8 may include the MMS host 102, 200, and 300. In particular, the processing system 814 may include the processor 202. Further, the processing system 814 described in relation to FIG. 8 may include the MMS client 104, 250, and 350. In particular, the processing system 814 may include the processor 252.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of serving media from a media server, comprising:
establishing a logical link with a client utilizing an Internet Protocol interface;
initiating, over the logical link, a streaming session with the client;
retrieving media content from a media source; and
serving the media content to the client over the logical link.

2. The method of claim 1, wherein the media content comprises at least one of: audio data, video data, picture data, text data, graphic data, sensor data, or metadata.

3. The method of claim 1, wherein the media source comprises at least one of: locally stored media contents, network-provided media contents, or live user-generated media contents.

4. The method of claim 3, wherein the network-provided media contents comprise at least one of: an over-the-air broadcast, a forward-link only broadcast, a live media stream provided from a remote device, Internet-based media content, or a video telephony session.

5. The method of claim 1, further comprising:
receiving capability information from the client, corresponding to the client's capability to utilize the media content.

6. The method of claim 5, wherein the receiving of the capability information occurs in response to the initiating of the streaming session with the client.

7. The method of claim 5, further comprising sending a request to the client for the capability information,
wherein the receiving of the capability information occurs in response to the request.

8. The method of claim 1, further comprising:
retrieving information related to the media content from the media source;
compiling an index corresponding to the information; and
providing the index to the client.

9. The method of claim 8, wherein the information related to the media content comprises meta-data associated with the media content.

10. The method of claim 1, wherein the initiating of the streaming session comprises utilizing a user interface on the media server to initiate the streaming session with the client.

11. The method of claim 1, further comprising:
altering the media content prior to the serving of the media content to the client.

12. The method of claim 11, wherein the altering of the media content comprises at least one of: applying a wrapper to the media content; altering spatial properties of video media content; altering temporal properties of the media content; altering information entropy of the video content; or multiplexing a plurality of associated media contents into a single stream.

13. The method of claim 11, wherein the altering of the media content comprises demultiplexing audio and video portions of multimedia media content.

14. The method of claim 13, wherein the serving of the media content comprises serving only one of the audio portion or the video portion of the multimedia media content to the client.

15. The method of claim 11, wherein the altering of the media content comprises converting two-dimensional video media content into three-dimensional video media content.

16. The method of claim 11, wherein the altering of the media content comprises transcoding the media content from a first format to a second format.

17. The method of claim 16, wherein the transcoding of the media content comprises at least one of increasing or decreasing a compression ratio of the media content.

18. The method of claim 1, further comprising:
branching the media content by duplicating the media content into a plurality of media content branches,
wherein the serving of the media content comprises serving one of the plurality of media content branches.

19. The method of claim 18, wherein the branching of the media content is adapted to enable substantially simultaneous multi-user playback of the media content.

20. The method of claim 18, further comprising:
locally rendering the media content corresponding to one of the plurality of media content branches on the media server.

21. The method of claim 20, wherein the serving of the media content to the client is adapted to enable substantially simultaneous playback of the media content with the local rendering of the media content.

22. The method of claim 18, wherein the serving of the media content to the client comprises serving the plurality of media content branches to a corresponding plurality of clients.

23. The method of claim 22, wherein the serving of the plurality of media content branches to the corresponding plurality of clients is adapted to enable substantially simultaneous playback of the media content branches at the plurality of clients.

24. The method of claim 18, further comprising altering the media content corresponding to the one of the media content branches prior to the serving of the media content to the client.

25. The method of claim 24, wherein the altering of the media content comprises dynamically controlling at least one branching-related parameter in response to a change in at least one condition.

26. The method of claim 25, wherein the at least one branching-related parameter comprises at least one of: an encoding of the media content, a data rate of transmission of the media content, or an existence of a link to a client.

27. The method of claim 25, wherein the at least one condition comprises at least one of: channel conditions of the logical link with the client, an availability of one or more clients, or a request for an initiation or termination of a link with one or more clients.

28. The method of claim 1, further comprising:
receiving and responding to feedback information from the client.

29. The method of claim 28, wherein the feedback information comprises at least one of: channel conditions of the logical link, error concealment measures taken by the client, or playback control commands from the client.

30. The method of claim 1, wherein the logical link comprises a plurality of forward links from the media server to a plurality of clients.

31. The method of claim 1, wherein the logical link comprises a broadcasting forward link from the media server to a plurality of clients.

32. The method of claim 1, wherein the logical link comprises a plurality of backward links from a plurality of clients to the media server.

33. The method of claim 1, wherein the logical link comprises a direct wired or wireless interface with the client.

34. A method of receiving, at a client, media from a media server, comprising:
discovering the media server;
subscribing to the media server; and
receiving media content over a logical link established by the media server.

35. The method of claim 34, further comprising:
sharing capability information with the server corresponding to a capability to utilize the media content.

36. The method of claim 34, wherein the logical link comprises a plurality of forward links from a plurality of media servers to the client.

37. The method of claim 34, wherein the logical link comprises a plurality of backward links from the client to a plurality of media servers.

38. The method of claim 34, further comprising:
initiating a streaming session with the media server; and
receiving second media content over the streaming session.

39. The method of claim 34, further comprising: rendering the media content in real-time as the media content is received.

40. An apparatus for serving media, comprising:
means for establishing a logical link with a client utilizing an Internet Protocol interface;
means for initiating, over the logical link, a streaming session with the client;
means for retrieving media content from a media source; and
means for serving the media content to the client over the logical link.

41. The apparatus of claim 40, further comprising:
means for receiving capability information from the client, corresponding to the client's capability to utilize the media content.

42. The apparatus of claim 40, further comprising:
means for retrieving information related to the media content from the media source;
means for compiling an index corresponding to the information; and
means for providing the index to the client.

43. The apparatus of claim 40, wherein the means for initiating the streaming session comprises means for utilizing a user interface on the media server to initiate the streaming session with the client.

44. The apparatus of claim 40, further comprising:
means for altering the media content prior to the serving of the media content to the client.

45. The apparatus of claim 44, wherein the means for altering the media content comprises at least one of: means for applying a wrapper to the media content; means for altering spatial properties of video media content; means for altering temporal properties of the media content; means for altering information entropy of the video content; or means for multiplexing a plurality of associated media contents into a single stream.

46. The apparatus of claim 44, wherein the means for altering the media content comprises means for demultiplexing audio and video portions of multimedia media content.

47. The apparatus of claim 46, wherein the means for serving the media content comprises means for serving only one of the audio portion or the video portion of the multimedia media content to the client.

48. The apparatus of claim 44, wherein the means for altering the media content comprises means for converting two-dimensional video media content into three-dimensional video media content.

49. The apparatus of claim 44, wherein the means for altering the media content comprises means for transcoding the media content from a first format to a second format.

50. The apparatus of claim 49, wherein the means for transcoding the media content comprises means for at least one of increasing or decreasing a compression ratio of the media content.

51. The apparatus of claim 40, further comprising:
means for branching the media content by duplicating the media content into a plurality of media content branches,
wherein the means for serving the media content comprises means for serving one of the plurality of media content branches.

52. The apparatus of claim 51, wherein the means for branching the media content is adapted to enable substantially simultaneous multi-user playback of the media content.

53. The apparatus of claim 51, further comprising:
means for locally rendering the media content corresponding to one of the plurality of media content branches on the media server.

54. The apparatus of claim 53, wherein the means for serving the media content to the client is adapted to enable substantially simultaneous playback of the media content with the local rendering of the media content.

55. The apparatus of claim 51, wherein the means for serving the media content to the client comprises means for serving the plurality of media content branches to a corresponding plurality of clients.

56. The apparatus of claim 55, wherein the means for serving the plurality of media content branches to the corresponding plurality of clients is adapted to enable substantially simultaneous playback of the media content branches at the plurality of clients.

57. The apparatus of claim 51, further comprising means for altering the media content corresponding to the one of the media content branches prior to the serving of the media content to the client.

58. The apparatus of claim 57, wherein the means for altering the media content comprises means for dynamically controlling at least one branching-related parameter in response to a change in at least one condition.

59. The apparatus of claim 40, wherein the logical link comprises a direct wired or wireless interface with the client.

60. A computer program product, comprising:
a computer-readable medium comprising code for:
establishing a logical link with a client utilizing an Internet Protocol interface;
initiating, over the logical link, a streaming session with the client;
retrieving media content from a media source; and
serving the media content to the client over the logical link.

61. The computer program product of claim 60, wherein the computer-readable medium further comprises code for:
receiving capability information from the client, corresponding to the client's capability to utilize the media content.

62. The computer program product of claim 60, wherein the computer-readable medium further comprises code for:
retrieving information related to the media content from the media source;
compiling an index corresponding to the information; and
providing the index to the client.

63. The computer program product of claim 60, wherein the code for initiating the streaming session comprises code for utilizing a user interface on the media server to initiate the streaming session with the client.

64. The computer program product of claim 60, wherein the computer-readable medium further comprises code for:
altering the media content prior to the serving of the media content to the client.

65. The computer program product of claim 64, wherein the code for altering the media content comprises at least one of: code for applying a wrapper to the media content; code for altering spatial properties of video media content; code for altering temporal properties of the media content; code for altering information entropy of the video content; or code for multiplexing a plurality of associated media contents into a single stream.

66. The computer program product of claim 64, wherein the code for altering the media content comprises code for demultiplexing audio and video portions of multimedia media content.

67. The computer program product of claim 66, wherein the code for serving the media content comprises code for serving only one of the audio portion or the video portion of the multimedia media content to the client.

68. The computer program product of claim 64, wherein the code for altering the media content comprises code for converting two-dimensional video media content into three-dimensional video media content.

69. The computer program product of claim 64, wherein the code for altering the media content comprises code for transcoding the media content from a first format to a second format.

70. The computer program product of claim 69, wherein the code for transcoding the media content comprises code for at least one of increasing or decreasing a compression ratio of the media content.

71. The computer program product of claim 60, wherein the computer-readable medium further comprises code for:
branching the media content by duplicating the media content into a plurality of media content branches,
wherein the serving the media content comprises serving one of the plurality of media content branches.

72. The computer program product of claim 71, wherein the code for branching the media content is adapted to enable substantially simultaneous multi-user playback of the media content.

73. The computer program product of claim 71, wherein the computer-readable medium further comprises code for:
locally rendering the media content corresponding to one of the plurality of media content branches on the media server.

74. The computer program product of claim 73, wherein the code for serving the media content to the client is adapted to enable substantially simultaneous playback of the media content with the local rendering of the media content.

75. The computer program product of claim 71, wherein the code for serving the media content to the client comprises serving the plurality of media content branches to a corresponding plurality of clients.

76. The computer program product of claim 75, wherein the code for serving the plurality of media content branches to the corresponding plurality of clients is adapted to enable substantially simultaneous playback of the media content branches at the plurality of clients.

77. The computer program product of claim 71, further comprising code for altering the media content corresponding to the one of the media content branches prior to the serving of the media content to the client.

78. The computer program product of claim 77, wherein the code for altering the media content comprises dynamically controlling at least one branching-related parameter in response to a change in at least one condition.

79. The computer program product of claim 60, wherein the logical link comprises a direct wired or wireless interface with the client.

80. An apparatus for serving media, comprising:
at least one processor; and
a memory coupled to the at least one processor,
wherein the at least one processor is configured to:
establish a logical link with a client utilizing an Internet Protocol interface;
initiate, over the logical link, a streaming session with the client;
retrieve media content from a media source; and
serve the media content to the client over the logical link.

81. The apparatus of claim 80, wherein the at least one processor is further configured to:
receive capability information from the client, corresponding to the client's capability to utilize the media content.

82. The apparatus of claim 80, wherein the at least one processor is further configured to:
retrieve information related to the media content from the media source;
compile an index corresponding to the information; and
provide the index to the client.

83. The apparatus of claim 80, wherein the initiating the streaming session comprises utilizing a user interface on the media server to initiate the streaming session with the client.

84. The computer program product of claim 80, wherein the computer-readable medium further comprises code for:
altering the media content prior to the serving of the media content to the client.

85. The apparatus of claim 84, wherein the altering of the media content comprises at least one of: applying a wrapper to the media content; altering spatial properties of video media content; altering temporal properties of the media content; altering information entropy of the video content; or multiplexing a plurality of associated media contents into a single stream.

86. The apparatus of claim 84, wherein the altering of the media content comprises demultiplexing audio and video portions of multimedia media content.

87. The apparatus of claim 86, wherein the serving of the media content comprises serving only one of the audio portion or the video portion of the multimedia media content to the client.

88. The apparatus of claim 84, wherein the altering of the media content comprises converting two-dimensional video media content into three-dimensional video media content.

89. The apparatus of claim 84, wherein the altering of the media content comprises transcoding the media content from a first format to a second format.

90. The apparatus of claim 89, wherein the transcoding of the media content comprises at least one of increasing or decreasing a compression ratio of the media content.

91. The apparatus of claim 80, wherein the at least one processor is further configured to:
branching the media content by duplicating the media content into a plurality of media content branches,
wherein the serving the media content comprises serving one of the plurality of media content branches.

92. The apparatus of claim 91, wherein the branching of the media content is adapted to enable substantially simultaneous multi-user playback of the media content.

93. The apparatus of claim 91, wherein the at least one processor is further configured to:
locally rendering the media content corresponding to one of the plurality of media content branches on the media server.

94. The apparatus of claim 93, wherein the serving the media content to the client is adapted to enable substantially simultaneous playback of the media content with the local rendering of the media content.

95. The apparatus of claim 91, wherein the serving the media content to the client comprises serving the plurality of media content branches to a corresponding plurality of clients.

96. The apparatus of claim 95, wherein the serving the plurality of media content branches to the corresponding plurality of clients is adapted to enable substantially simultaneous playback of the media content branches at the plurality of clients.

97. The apparatus of claim 91, further comprising altering the media content corresponding to the one of the media content branches prior to the serving of the media content to the client.

98. The apparatus of claim 97, wherein the altering the media content comprises dynamically controlling at least one branching-related parameter in response to a change in at least one condition.

99. The apparatus of claim 80, wherein the logical link comprises a direct wired or wireless interface with the client.
